(19) United States
(12) Patent Application Publication
(10) Pub. No.: US 2022/0110721 A1
(43) Pub. Date: Apr. 14, 2022

(54) ORTHODONTIC DEVICES AND METHODS OF USE

(71) Applicant: Braces on Demand Inc., Hicksville, NY (US)

(72) Inventors: Thomas Patrick Shannon, Byron Center, MI (US); Colin James Corey, Carlsbad, CA (US); Ammar Ahmed Syed, Unionville (CA)

(21) Appl. No.: 17/498,363

(22) Filed: Oct. 11, 2021

Related U.S. Application Data
(60) Provisional application No. 63/091,671, filed on Oct. 14, 2020.

(51) Int. Cl. A61C 7/14; A61C 7/08; A61C 7/00; B33Y 80/00

(52) U.S. Cl. CPC A61C 7/148; B33Y 80/00; A61C 7/002; A61C 7/08

(57) ABSTRACT

In some embodiments, apparatuses, and methods are provided herein pertaining to orthodontic devices. In some embodiments, a hybrid attachment for orthodontic use comprises a body, wherein the body comprises an archwire slot, wherein the archwire slot is configured to receive an archwire, a bonding surface, wherein the bonding surface is configured to bond to a facial surface of a patient's tooth via an adhesive, and wherein the bonding surface is located on a first side of the body, and a facial surface, wherein the facial surface has a nonnegative draft normal to the facial surface of the patient's tooth, wherein the facial surface is configured to releasably retain a removable orthodontic aligner, and wherein the facial surface is located on a second side of the body.

### CROSS-REFERENCE TO RELATED APPLICATIONS

This application claims priority from and benefit of U.S. Provisional Patent Application Ser. No. 63/091,671, filed Oct. 14, 2020, which is hereby incorporated by reference herein in its entirety.

### TECHNICAL FIELD

This invention relates generally to orthodontics and, more specifically, orthodontic devices.

### BACKGROUND

Orthodontic clinicians seek to correct malocclusions by use of many different devices, such as braces, retainers, aligners, pallet expanders, positioners, etc. Different types of devices can be used in different circumstances and may have different strengths and weaknesses. Clinicians often use different devices in series to achieve a desired result. As one example, a clinician may begin by using braces for initial tooth movement and then a retainer or aligner to maintain tooth position and/or create subsequent tooth movement. Unfortunately, such serial use of these devices requires clinicians to adhere devices to the patient's teeth on multiple occasions. Such duplicative work is not only time-consuming, but also costly. Accordingly, a need exists for orthodontic devices that can be used in multiple stages of treatment.

### BRIEF DESCRIPTION OF THE DRAWINGS

Disclosed herein are embodiments of systems, apparatuses, and methods pertaining orthodontic devices. This description includes drawings, wherein:

FIG. 1 depicts a portion 100 of a patient's mouth wherein hybrid attachments 106 are secured to at least some teeth 102 in the patient's mouth, according to some embodiments;

FIGS. 2A and 2B are perspective and top views, respectively, of a hybrid attachment 200, according to some embodiments;

FIGS. 3A and 3B are side and front elevational views, respectively, of a hybrid attachment 300, according to some embodiments;

FIG. 4A is a lower perspective view of a hybrid attachment 400, according to some embodiments;

FIG. 4B is a perspective view of a hybrid attachment 400 including a door 418, according to some embodiments;

FIGS. 5A and 5B are perspective and top views, respectively, of a hybrid attachment 500, according to some embodiments;

FIGS. 6A and 6B are perspective and side elevational views, respectively, of a hybrid attachment 600 including an undercut 620, according to some embodiments;

FIGS. 7A-7C depict hybrid attachments 702 in a kit 700, according to some embodiments;

FIG. 8 is a flow chart including example operations for use of an orthodontic system, according to some embodiments;

FIG. 9 is a flow chart including example operations for providing data files associated with orthodontic appliances, according to some embodiments; and

FIG. 10 is a block diagram of a system 1000 for providing data files associated with orthodontic appliances, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein pertaining to orthodontic devices. In some embodiments, a hybrid attachment for orthodontic use comprises a body, wherein the body comprises an archwire slot, wherein the archwire slot is configured to receive an archwire, a bonding surface, wherein the bonding surface is configured to bond to a facial surface of a patient's tooth via an adhesive, and wherein the bonding surface is located on a first side of the body, and a facial surface, wherein the facial surface has a nonnegative draft normal to the facial surface of the patient's tooth, wherein the facial surface is configured to releasably retain a removable orthodontic aligner, and wherein the facial surface is located on a second side of the body.

As previously discussed, clinicians use many types of orthodontic devices to correct malocclusions. One of the most common types of appliances is braces. Braces include multiple devices, such as brackets, archwires, and ligatures. The brackets are affixed to a patient's teeth and the archwire passes through slots in the brackets designed to receive the archwire. The ligatures secure the archwire within the slots. The archwire applies force on the brackets, causing movement of the patient's teeth. One of the advantages of braces is that braces are quite effective in moving the patient's teeth. For example, braces can be used to achieve rotational and/or linear motion of one or more of the patient's teeth. However, while braces are quite effective at moving the patient's teeth, some patient's find braces uncomfortable and/or unsightly.

Another common orthodontic device is an aligner. An aligner is a removable orthodontic device that is worn within a patient's mouth. The aligner interacts with attachments that are affixed to a patient's teeth. The interaction between the aligner and the attachments applies force to the wedges, causing movement of the patient's teeth. In some cases, the aligners can be formed of clear, or nearly clear, material and the attachments can be formed from a tooth-colored material, such as an orthodontic adhesive. In such cases, the aligners can be quite discreet. However, while aligners can be quite discreet, aligners generally are not as effective at moving the patient's teeth as braces. For example, while aligners may be effective at providing linear forces on a patient's teeth, they are typically less effective than braces at achieving rotational motion of the patient's teeth.

Some clinicians use a combination of braces and aligners when treating patients in an attempt to take advantage of the benefits of both braces and aligners. For example, a clinician may begin treatment using braces. In such instances, clinician may use the braces to achieve the initial movement of the patient's teeth. Once the initial movement is achieved, an aligner can be used to achieve final movement of the patient's teeth. Before using the aligner, the clinician removes the braces from the patient's mouth, including removing the brackets from the patient's teeth. An aligner is created for the patient's mouth and the clinician secures wedges to the patient's mouth to work in concert with the aligner. The patient uses the aligner by inserting it in, and removing it from, his or her mouth as prescribed by the clinician. By using the aligner for the final movement of the patient's teeth, the length of time that the patient has braces is decreased. While this is generally viewed as a positive by patients, such serial treatment requires an increased number of visits to the orthodontic clinician as well as an increased number of orthodontic devices. Such duplicative work is not only time-consuming, but also costly.

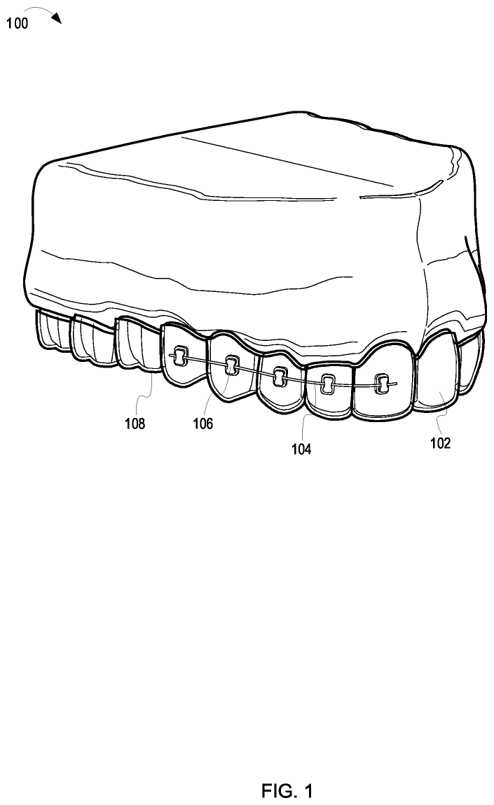

Described herein are systems, methods, and apparatuses that seek to eliminate, or at least minimize, the drawbacks of the aforementioned serial use of multiple orthodontic devices. In one embodiment, hybrid attachments are utilized that can be used for both braces and aligners. For example, a hybrid attachment can include an archwire slot for use with an archwire to achieve movement of a patient's teeth. Additionally, the hybrid attachment can include a facial surface that is configured to releasably retain an aligner. Accordingly, the hybrid attachment can be used for in a manner similar to braces with an archwire and with aligners. The discussion of FIG. 1 provides an overview of such hybrid attachments when used with archwires and aligners.

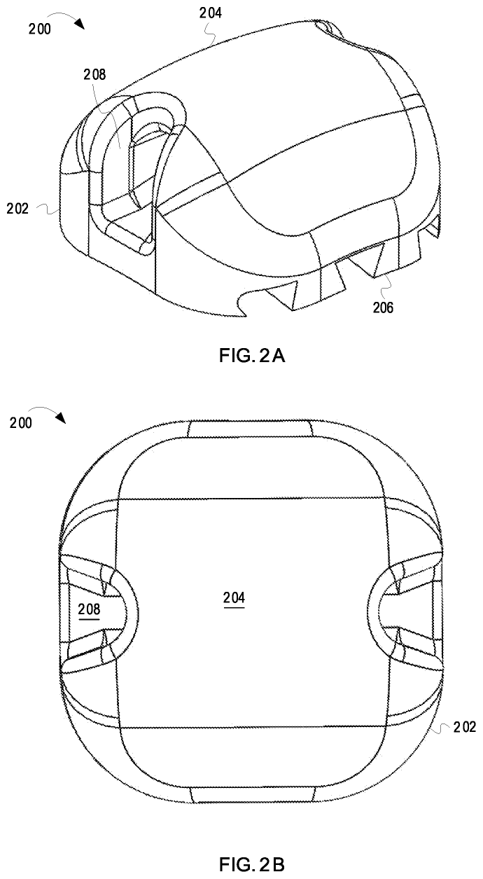

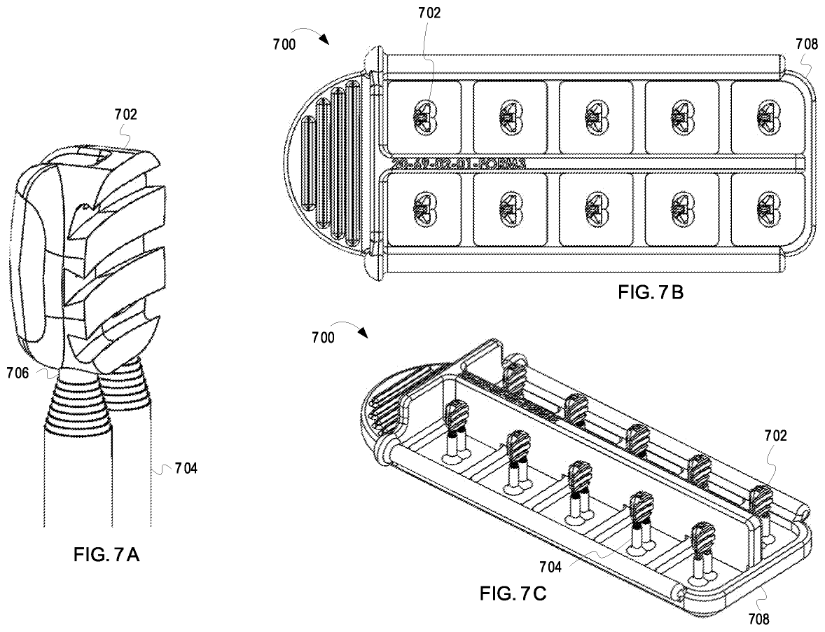

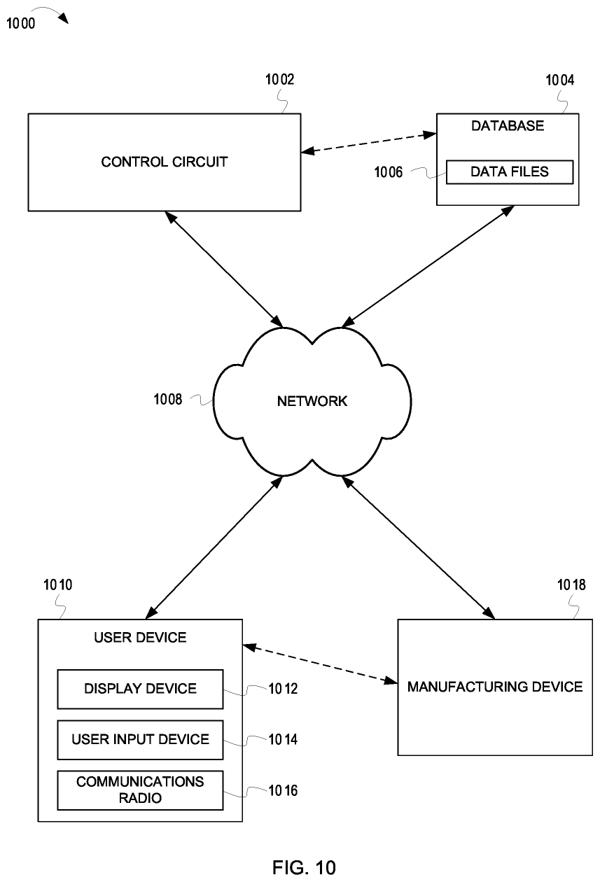

FIG. 1 depicts a portion 100 of a patient's mouth wherein hybrid attachments 106 are secured to at least some teeth 102 in the patient's mouth, according to some embodiments. The hybrid attachments 106 are secured to the patient's teeth 102 much like traditional brackets. For example, the hybrid attachments 106 can be secured to the patient's teeth 102 via an adhesive. The hybrid attachments 106 include archwire slots (shown in more detail, in various embodiments, in FIGS. 2-6). The archwire slots are configured to receive an archwire 104. Much like with traditional braces, the archwire 104 provides a force on the hybrid attachments 106 causing movement of the patient's teeth 102. In this regard, the hybrid attachments 106 can perform much like traditional brackets for braces. In some embodiments, the hybrid attachments 106 can be created via an additive manufacturing process (as described with respect to FIGS. 7A-7C and 10). In such embodiments, the hybrid attachments 106 can be additively manufactured with a resin that makes the hybrid attachments 106 more discreet than traditional brackets. For example, the resin can be clear, nearly clear, white, tooth-colored based on the color of the patient's teeth 102, etc.

However, unlike traditional brackets for braces, the hybrid attachments 106 are configured to releasably retain a removable orthodontic aligner 108 (referred to herein simply as an “aligner” for ease of discussion). The aligner 108 is generally a mouthpiece that is designed to slip over the patient's teeth 102 and maintain the positioning of the patient's teeth 102 and/or cause movement of the patient's teeth. Accordingly, the aligner 108 can be of any suitable type and made from any suitable material. For example, in one embodiment, the aligner 108 can be a clear aligner that is formed from a clear, or nearly clear, plastic. In some cases, an orthodontic clinician may utilize multiple aligners during a course of treatment. For example, an orthodontic clinician may prescribe a series of aligners that are used in sequence to reach a desired position for each of the patient's teeth 102. In such embodiments, the hybrid attachments 106 can be used with each of the aligners in the series of aligners.

Because the hybrid attachments 106 are configured to receive an archwire 104 and releasably retain the aligner 108, a clinician is provided with many treatment options. For example, the orthodontic clinician can use the archwire 104 and aligner 108, in series or in parallel, in concert with the hybrid attachments 106. For example, in a serial treatment, the orthodontic clinician can first use the archwire 104 (or aligner 108) in concert with the hybrid attachment 106, and second use the aligner 108 (or archwire 104) in concert with the hybrid attachments 106. That is, the orthodontic clinician could start with either archwire 104 treatment or the aligner 108 treatment. Further, if deemed advisable by the orthodontic clinician, the orthodontic clinician could alter between the two types of treatments. For example, the orthodontic clinician could begin with the archwire 104 treatment, move to the aligner 108 treatment, return to the archwire 108 treatment, etc. In some cases, the orthodontic clinician may not need to remove the hybrid attachments 106 from the patient's teeth when going between the archwire 104 treatment and the aligner 108 treatment. As an example of a parallel treatment, the orthodontic clinician can use both the archwire 104 and the aligner 108 simultaneously with the hybrid attachments 106. For example, the orthodontic clinician can prescribe use of the aligner 108 at all times, a portion of the time (e.g., at night, except when eating, etc.), etc. while the archwire 104 is secured within the hybrid attachments 106. Because of the flexibility with which the hybrid attachments can be used, the orthodontic clinician is provided with a wide range of treatment options, only a small number of which are discussed herein due to space constraints and for ease of readability, though all possible treatment options are envisioned with use of the hybrid attachments 106.

While the discussion of FIG. 1 provides background information regarding hybrid attachments and their use with archwires and aligners, the discussion of FIGS. 2-6 provide additional information regarding hybrid attachments

FIGS. 2A and 2B are perspective and top views, respectively, of a hybrid attachment 200, according to some embodiments. The hybrid attachment 200 comprises a body 202, the body 202 comprising an archwire slot 208, a bonding surface 206, and a facial surface 204. The bonding surface 206 is configured to bond to a facial surface of a patient's tooth, for example, via an adhesive. That is, the bonding surface 206 primarily faces the patient's tooth. The facial surface 204 the surface of the body 202 that generally faces away from the patient's tooth. For example, in one in embodiment, the bonding surface 206 is located on one side (e.g., a first side) of the body 202 of the hybrid attachment 200 and the facial surface 204 is located on another side (e.g., a second side) of the body 202 of the hybrid attachment 200.

The archwire slot 208 proceeds through the body 202 of the hybrid attachment 200. The archwire slot 208 is a channel through the body 202 of the hybrid attachment 200 that is configured to receive an archwire. The archwire provides force on the body 202 of the hybrid attachment 200 via the archwire slot 208 to cause movement of a tooth to which the hybrid attachment 200 is secured (e.g., bonded). Accordingly, the archwire slot 208, as well as the archwire, can take any suitable shape. For example, the archwire slot 208 can be straight with respect to a tangent line of the facial surface of the patient's tooth, curve (e.g., with respect to the patient's tooth, the tangent line of the facial surface of the patient's tooth, the body 202 of the hybrid attachment, etc.) and vary in dimension, and the archwire can be round, squared, etc. and likewise vary in dimension. As depicted in FIGS. 2A and 2B, the archwire slot 208 is enclosed. Such a design may aid in releasable retention of the aligner, as the enclosed archwire slot 208 provides for a smooth facial surface 204, as discussed in more detail below.

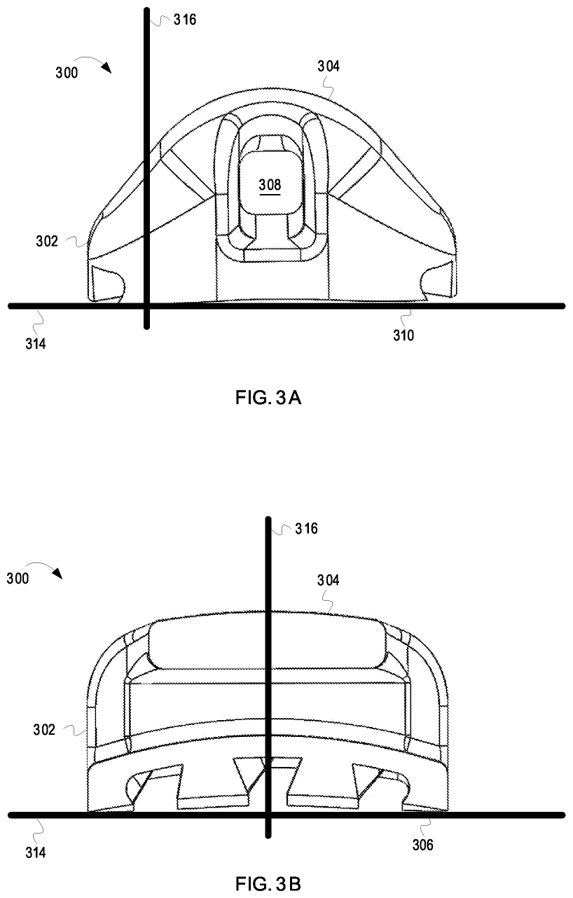

In addition to use with an archwire, the hybrid attachment 200 can be used with an aligner. That is, the hybrid attachment 200 is configured to releasably retain an aligner. When used with an aligner, the facial surface 204 of the hybrid attachment 200 releasably retains the aligner, as described in more detail with respect to FIGS. 3A and 3B.

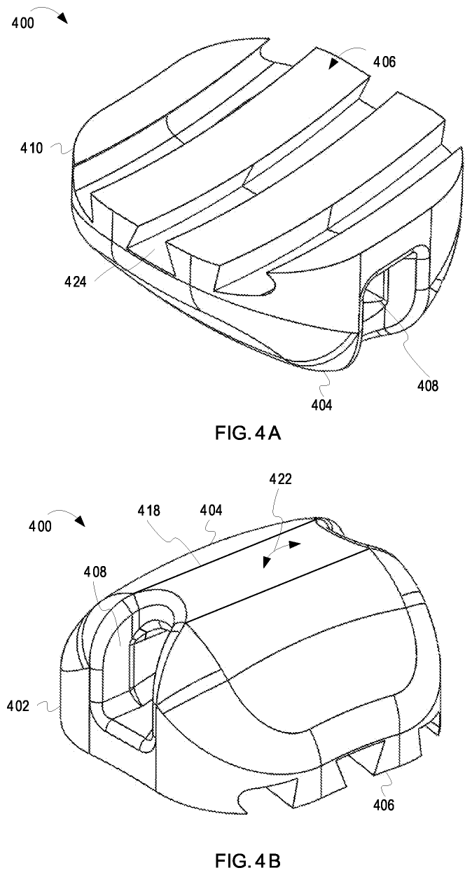

FIGS. 3A and 3B are side and front elevational views, respectively, of a hybrid attachment 300, according to some embodiments. Like the hybrid attachment depicted in FIGS. 2A and 2B, the hybrid attachment 300 depicted in FIGS. 3A and 3B comprises a body 302 comprising an archwire slot 308, a facial surface 304 and a bonding surface 306. The bonding surface 306 has a perimeter 310 (i.e., the perimeter of the bonding surface), discussed in more detail with respect to FIG. 4A.

As previously discussed, when the hybrid attachment 300 is used in concert with an aligner, the facial surface 304 of the hybrid attachment 300 releasably retains the aligner. That is, an inner surface of the aligner (i.e., the surface of the aligner facing the patient's teeth, as opposed to an outer surface that faces away from the patient's teeth) interacts with the facial surface 304 of the hybrid attachment 300 to releasably retain the aligner. The inner surface of the aligner can interact with the facial surface 304 of the aligner via a pressure fit and/or friction between the inner surface of the aligner and the facial surface 304 of the hybrid attachment 300.

In order for the facial surface 304 of the hybrid attachment 300 to releasably retain the aligner, in one embodiment, it is beneficial for the facial surface 304 of the hybrid attachment 300 to include as few features as possible upon which the aligner can become caught, thus preventing ease of removal of the aligner from the patient's mouth. As but one example, traditional brackets include tiewings that protrude from the brackets. Such tiewings would make removal of an aligner difficult, if not impossible. Accordingly, the hybrid attachment 300 features a smooth facial surface 304.

In addition to the facial surface 304 being smooth, in some embodiments, the facial surface 304 lacks features, such as undercuts, upon which the aligner could be caught. In such embodiments, the facial surface 304 of the hybrid attachment features a nonnegative draft (i.e., draft 0) with respect to a direction 316 normal to a facial surface of a patient's tooth (it should be noted that the facial surface of the patient's tooth is approximated by a line 314 in FIG. 3). Put simply, in one embodiment, the facial surface has a zero or greater draft with respect to the direction 316.

While the discussion of FIGS. 3A and 3B provide additional detail regarding the facial surface of a hybrid attachment, the discussion of FIG. 4A provides additional detail regarding the bonding surface of a hybrid attachment.

FIG. 4A is a lower perspective view of a hybrid attachment 400, according to some embodiments. Like the hybrid attachment depicted in FIGS. 3A and 3B, the hybrid attachment 400 depicted in FIG. 4A includes a body, an archwire slot 408, a bonding surface 406, and a facial surface 408. The bonding surface has a perimeter 410. The perimeter 410 of the bonding surface is the edge of the bonding surface that contacts a patient's tooth when the hybrid attachment 400 is secured to the patient's tooth, or nearly contacts the patient's tooth (e.g., if the hybrid attachment 400 is secured to the patient's tooth via an adhesive, the perimeter 410 of the bonding surface 406 may not directly contact the facial surface of the patient's tooth, as there may be a thin layer of adhesive between the patient's tooth and the perimeter 410 of the bonding surface 406). In some embodiments, the fit of the perimeter 410 of the bonding surface 406 may be substantially flush against the facial surface of the patient's tooth. Such substantially flush fitment may allow the aligner to more easily release from the hybrid attachment 400, and thus the patient's teeth. Additionally, in some embodiments, the bonding surface 406 may include channels 424. The channels allow adhesive material to flow between the facial surface of the patient's tooth and the bonding surface 406 of the hybrid attachment creating a more secure bond between the hybrid attachment 400 and the patient's tooth.

While the discussion of FIGS. 2-4A describe a hybrid attachment that is manufactured without access point for the archwire slot, the discussion of FIG. 4B describes a hybrid attachment that includes an access point to the archwire slot, for example, a door.

FIG. 4B is a perspective view of a hybrid attachment 400 including a door 418, according to some embodiments. Like the hybrid attachment depicted in FIG. 4A, the hybrid attachment 400 depicted in FIG. 4B comprises a body 402 comprising an archwire slot 408, a facial surface 404, and a bonding surface 406. As previously discussed, in some embodiments, an enclosed archwire slot 408 provides a smooth facial surface 404 with which an aligner can be releasably retained. Additionally, an enclosed archwire slot 408 can further improve the smoothness, as well as aid in creation of the nonnegative draft, of the facial surface 404 while still allowing for ligation of the archwire without the need for separate ligatures, such as elastic bands. In such embodiments, this can be achieved with the hybrid attachment 400 via self-ligation. Such self-ligation can be achieved with an enclosed archwire slot of a hybrid attachment that is a single part (as depicted in FIGS. 2-4A) and/or with the door 418 (as depicted in FIG. 4B).

The hybrid attachment 400 depicted in FIG. 4B includes the door 418 that provides access to and encloses the archwire slot 408. For example, the door can be hinged on the body 402 and open and close, as indicated by an arrow 422. As indicated by the arrow 422, the door can pivot between opened and closed positions to allow access to the archwire slot 408. In one embodiment, the body 402 and the door 422 are manufactured as a single piece. In such embodiments, the hinge can be a thinner or weakened portion of the body 402 that allows the door to pivot between the open and closed positions. In other embodiments, the body 402 and the door 422 can be manufactured as distinct parts. In such embodiments, the door 422 can be secured to the body before placement of the hybrid attachment 400 on a patient's tooth (e.g., by the orthodontic clinician or by the manufacturer of the hybrid attachment) or after placement of the hybrid attachment on the patient's tooth.

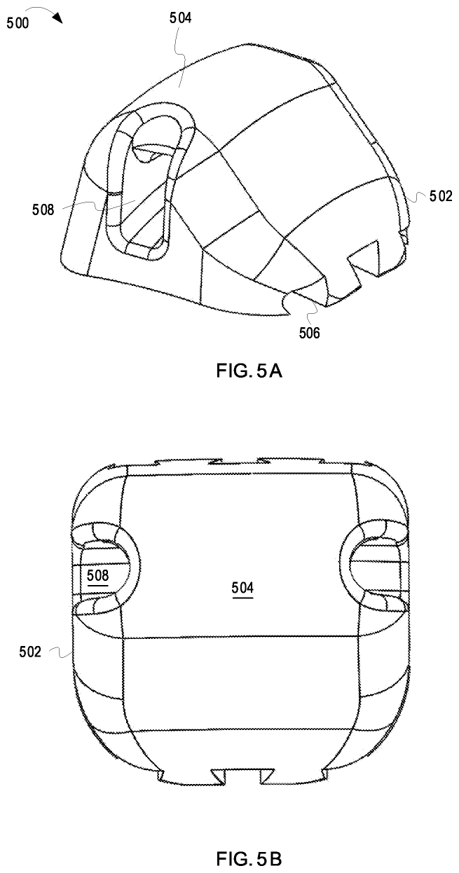

While FIGS. 2-4 depict a hybrid attachment that is relatively symmetric cross-sectionally in two planes normal to the bonding surface, FIGS. 5A and 5B depict a hybrid attachment that is relatively symmetric cross-sectionally in only one plane normal to the bonding surface.

FIGS. 5A and 5B are perspective and top views, respectively, of a hybrid attachment 500, according to some embodiments. Like the hybrid attachments discussed previously, the hybrid attachment 500 comprises a body 502 comprising an archwire slot 508, a facial surface 504, and a facial surface 506. As previously discussed, an inner surface of an aligner interacts with the facial surface 506 to exert a force on a patient's tooth. In order to move the patient's teeth as desired, an orthodontic clinician may require specifically shaped hybrid attachments. Accordingly, the body 502, facial surface 504, and/or bonding surface 506 can be shaped in any suitable manner. That is, in some embodiments, the orthodontic clinician can specify a specific geometry for one or more of the body 502, facial surface 504, and/or bonding surface 506 of the hybrid attachment 500. FIGS. 5A and 5B depict an example hybrid attachment 500 geometry that differs from that of the hybrid attachment depicted in the other figures included herein. It should be noted that the geometries of the hybrid attachments depicted herein are not intended to be limiting. Rather, a nearly infinite number of geometries can be used, dependent upon the desired movement of the patient's teeth and the geometries provided herein are but examples to indicate that alternative geometries are possible.

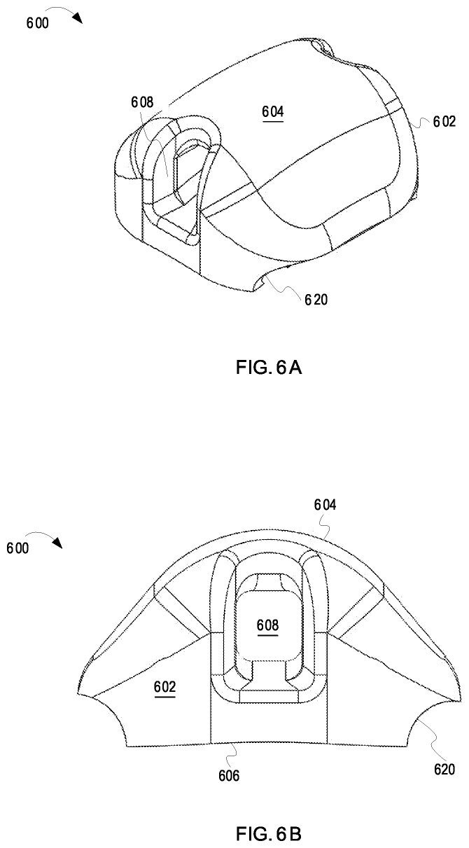

While FIGS. 2-5 depict hybrid attachments that do not have undercuts, FIGS. 6A-6B depict hybrid attachments including undercuts.

FIGS. 6A and 6B are perspective and side elevational views, respectively, of a hybrid attachment 600 including an undercut 620, according to some embodiments. Like the hybrid attachments discussed previously, the hybrid attachment 600 comprises a body 600 comprising an archwire slot 608, a facial surface 604, and a bonding surface 606. Additionally, the hybrid attachment 600 includes an undercut 620. The undercut 620 can be used for ligation of an archwire withing the archwire slot 608. That is, if the archwire slot 608 is not enclosed, a ligature may be necessary to secure the archwire within the archwire slot 608. In such embodiments, the ligature can be secured to the hybrid attachment 600 via the undercut 620. However, it should be noted, that in some instances, it may be desirable for the hybrid attachment 600 to include an enclosed archwire slot 608 as well as the undercut 620.

To maintain the ability to releasably retain an aligner, a portion of the facial surface 604 can have a nonnegative draft with respect to a direction normal to a facial surface of the patient's tooth. As depicted in FIGS. 6A and 6B, the portion of the facial surface 604 does not include the undercut 620. Accordingly, the portion of the facial surface 604 interacts with an inner surface of the aligner to releasably retain the aligner within the patient's mouth.

While the discussion of FIGS. 1-6 describe hybrid attachments, the discussion of FIGS. 7A-7B describe the manufacture of hybrid attachments.

FIGS. 7A-7C depict hybrid attachments 702 in a kit 700, according to some embodiments. FIG. 7A generally depicts one of the hybrid attachments 702 affixed to support structures 704. The support structures 704 connect the hybrid attachments 702 to a carrier 708, as depicted in FIGS. 7B and 7C. The carrier 708 is configured to house the hybrid attachments 702. The kit 700 (also referred to as an “orthodontic kit”) generally comprises the hybrid attachments 702 and the carrier 708.

In one embodiment, the kit 700 is additively manufactured, such as by way of the techniques described in U.S. patent application Ser. No. 16/875,618 titled SYSTEMS AND METHODS FOR MANUFACTURE OF ORTHODONTIC APPLIANCES filed on May 15, 2020 and incorporated by reference herein in its entirety. With respect to the U.S. Patent Application Ser. No. 16/875,618, the hybrid attachments 702 would be a type of “orthodontic appliance.” As one example, the kit 700 can be additively manufactured by a 3D printing process. In such embodiments, the kit 700 can be additively manufactured as a single unit (e.g., structure). Accordingly, the carrier 708, hybrid attachments 702, and support structures 704 are additively manufactured as a single unit. Further, the kit 700 can be defined by a computer data file (e.g., a CAD file, such as an .stl file). The computer data file includes all of the data necessary to additively manufacture the kit 700. That is, the computer data file includes the data necessary to additively manufacture the carrier 708, the hybrid attachments 702, and the support structures 704.

As previously noted, the hybrid attachments 702 are secured to the carrier 708, and supported, by the support structures 704. That is, in embodiments in which the kit 700 is additively manufactured as a single unit, the support structures 704 provided a based upon which the hybrid attachments 702 can be additively manufactured. In one embodiment, the kit 700 can be manufactured such that the hybrid attachments 702 are easily severable from the support structures 704. For example, an orthodontic clinician can sever the hybrid attachments 702 from the support structures 704 with a tool (e.g., a knife) or by hand (e.g., by “breaking” the hybrid attachment 702 off of the support structures 704). Additionally, in some embodiments, the hybrid attachments 702 can be severed from the support structures 704 cleanly, such that no, little, or a controlled amount of residue remains on the hybrid attachments 702 once they have been removed from the support structures 704.

In one embodiment, easy severability is aided by the connection of the hybrid attachments 702 to the support structures 704. For example, the hybrid attachments 702 can be connected to the support structures via joints 706. The joints 706 can utilize any of many different configurations to make removal of the hybrid attachments 702 from the support structures 704 relatively simply. As one example, the joints 706 can include a stepped configuration, as shown in FIG. 7A. In one embodiment, the stepped configuration is defined by a layer-by-layer manner in a data file associated with the hybrid attachment 702. In this manner, the degree to which each layer of the stepped-configuration, the height of each layer of the stepped-configuration, the length of the stepped configuration, end dimension of the stepped configuration, etc. can be user-defined as desired based on the specific hybrid attachment 702 with which the support structures 704 are associated. As another example, the joint 706 can utilize a double taper configuration, as depicted in FIG. 3 of U.S. patent application Ser. No. 17/011,121 titled SYSTEMS AND METHODS FOR MANUFACTURING ORTHODONTIC APPLIANCES filed on Sep. 3, 2020 and incorporated by reference herein in its entirety. In the double taper configuration, both ends of the joint 706 taper to a section that is, for example, thinner than the rest of the support structure 704 or otherwise includes less material than the rest of the support structure 704. In one embodiment, the thinning of the support structure 704 at the joint 706 allows the hybrid attachment 702 to be detached from the support structures 704, and thus the carrier 708, by a user via physical input. The geometry of the joint 706 focuses stress from physical manipulation of the hybrid attachment 702 and/or carrier 708 at a desired location within the joint 706. Accordingly, such joint 706 geometry allows for a clean fracture of the material at, or near, the joint 706. In some embodiments, the hybrid attachment 702 can be separated from the support structures 706 without leaving any excess material (e.g., residue) on the hybrid attachment 702.

The kit 700 can be configurable and sold, or otherwise provided to, orthodontic clinicians as a single unit. The kit 700 can be configurable, as desired by the orthodontic clinician, to include different types of orthodontic appliances, such as hybrid attachment 702, brackets, etc., as described in U.S. patent application Ser. No. 16/875,618. Further, to aid in identifying the orthodontic appliances included in the kit 700, the kit can be marked, as described in more detail in U.S. patent application Ser. No. 17/011,071 titled SYSTEMS AND METHODS FOR MARKING ORTHODONTIC DEVICES filed on Sep. 3, 2020 and incorporated by reference herein in its entirety.

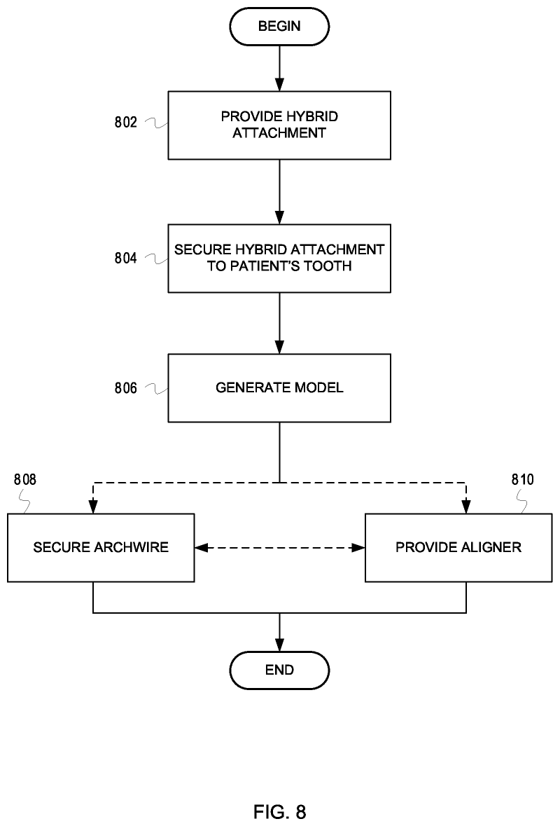

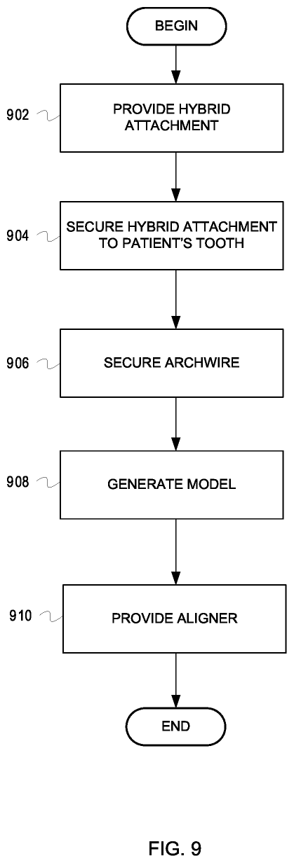

While the discussion of FIGS. 1-7 describes hybrid attachments, the discussion of FIGS. 8 and 9 provides additional detail regarding the use of hybrid attachments.

FIG. 8 is a flow chart including example operations for use of an orthodontic system, according to some embodiments. The flow begins at block 802.

At block 802, a hybrid attachment is provided. The hybrid attachment can be provided by an orthodontic clinician and/or a manufacturer of orthodontic appliances. The hybrid attachment comprises a body. An archwire slot is located on the body and the body includes a bonding surface and a facial surface. The bonding surface of the body is configured to bond to a facial surface of a patient's tooth via an adhesive. The facial surface of the body is configured to releasably retain an aligner. In one embodiment, to aid releasable retention of the aligner, the facial surface of the body has a nonnegative (i.e., zero or positive) draft with respect to a direction normal to the facial surface of the patient's tooth. All of the facial surface, or a portion of the facial surface, can have such a draft. One or more hybrid attachments can be provided. For example, an appropriate number of hybrid attachments for releasably retaining an aligner to the top and/or bottom row of a patient's teeth can be provided. The flow continues at block 804.

At block 804, the hybrid attachment is secured on a patient's tooth. For example, an orthodontic clinician can secure the hybrid attachment on the patient's tooth. The orthodontic clinician can secure the hybrid attachment on the patient's tooth, using any suitable means. As one example, the orthodontic clinician secures the hybrid attachment on the patient's tooth via an adhesive. In such embodiments, the bonding surface of the hybrid attachment will bond to the patient's tooth via the adhesive. Accordingly, all, some, or none of the bonding surface may contact the facial surface of the patient's tooth. The flow continues at block 806.

At block 806, a model of the patient's mouth is generated. For example, the model of the patient's mouth can be generated (e.g., created) from a physical impression and/or optical scan of the patient's mouth. In one embodiment, the model of the patient's mouth is generated after the hybrid attachment(s) is secured on the patient's tooth. Accordingly, in such embodiments, the model of the patient's mouth would include the hybrid attachment(s). The flow continues at block 808 or block 810. The flow can continue at either block 808 or block 810, dependent upon the treatment determined by the orthodontic clinician. Further, the flow can continue between block 808 and block 810, as described in more detail below.

At block 808, an archwire is secured via the hybrid attachment(s). For example, the orthodontic clinician can secure the archwire via the hybrid attachment(s). The orthodontic clinician secures the archwire in the archwire slot(s) of the hybrid attachment(s). If the orthodontic clinician chooses to secure the archwire, the hybrid attachment(s) can act in a manner similar to that of brackets in a traditional braces treatment. At this point, the flow may end. For example, if the orthodontic clinician at this point will use the hybrid attachments as brackets, no additional treatment may be required. However, in some embodiments, the orthodontic clinician may choose to use an aligner. The orthodontic clinician may choose to the use the aligned in series and/or parallel with the archwire. In either case, the flow continues at block 810.

At block 810, the aligner is provided. For example, the aligner can be provided by the orthodontic clinician and/or a manufacturer of orthodontic appliances. The aligner is created based on the model of the patient's mouth. Accordingly, in embodiments in which the model of the patient's mouth includes the hybrid attachment(s), the aligner is created based not only on the natural features of the patient's mouth but also the location, size, number, positions, etc. of the hybrid attachment(s). The aligner is configured to be releasably retained by the hybrid attachment(s). That is, an inner surface of the aligner is configured to interact with the facial surface(s) of the hybrid attachment(s) to releasably retain the aligner. Though FIG. 8 refers to provision of only a single aligner and the generation of only a single model of the patient's mouth, such is not required. For example, these steps can be repeated as many times as desired. For example, the orthodontic clinician may desire to include a number of aligners in the patient's treatment. In such embodiments, the orthodontic clinician may generate multiple models of the patient's mouth during treatment and provide multiple aligners throughout the patient's treatment. As previously noted, the use of archwire and an aligner can be performed in series and/or parallel. In a serial treatment, the orthodontic clinician may secure the archwire and leave he archwire (or a series of archwires) in place for a period of time. The orthodontic clinician may remove the archwire and provide the aligner. As another example, the orthodontic clinician may first utilize one or more aligners (e.g., at block 810) then subsequently utilize one or more archwires (e.g., at block 808) to treat the patient. Accordingly, the flow may move from block 806, to block 810, and then block 808. Further, in some embodiment and dependent upon the treatment of the patient, the flow may move back and forth between block 808 and block 810. In a parallel treatment, the orthodontic clinician may secure the archwire and provide one or more aligners to the patient for use while the archwire is secured.

FIG. 9 is a flow chart including example operations for providing data files associated with orthodontic appliances, according to some embodiments. The flow begins at block 902.

At block 902, a hybrid attachment is provided. The hybrid attachment can be provided by an orthodontic clinician and/or a manufacturer of orthodontic appliances. The hybrid attachment comprises a body. An archwire slot is located on the body and the body includes a bonding surface and a facial surface. The bonding surface of the body is configured to bond to a facial surface of a patient's tooth via an adhesive. One or more hybrid attachments can be provided. For example, an appropriate number of hybrid attachments for releasably retaining an aligner to the top and/or bottom row of a patient's teeth can be provided. The flow continues at block 904.

At block 904, the hybrid attachment is secured on a patient's tooth. For example, an orthodontic clinician can secure the hybrid attachment on the patient's tooth. The orthodontic clinician can secure the hybrid attachment on the patient's tooth, using any suitable means. As one example, the orthodontic clinician secures the hybrid attachment on the patient's tooth via an adhesive. In such embodiments, the bonding surface of the hybrid attachment will bond to the patient's tooth via the adhesive. Accordingly, all, some, or none of the bonding surface may contact the facial surface of the patient's tooth. The flow continues at block 906.

At block 906, an archwire is secured. For example, the orthodontic clinician can secure the archwire. The orthodontic clinician can secure the archwire within the archwire slot of the hybrid attachment(s). The archwire provides a force on the hybrid attachments, thus causing movement of the patient's teeth. As noted previously, the archwire slot can be enclosed and/or include an access means (e.g., a door). The flow continues at block 908.

At block 908, a model is generated. For example, a model of the patient's mouth can be generated. The model of the patient's mouth can be generated (e.g., created) from a physical impression and/or optical scan of the patient's mouth. In one embodiment, the model of the patient's mouth is generated after the hybrid attachment(s) is secured on the patient's tooth. Accordingly, in such embodiments, the model of the patient's mouth would include the hybrid attachment(s). The flow continues at block 910.

At block 910, the aligned is provided. For example, the aligner can be provided by the orthodontic clinician and/or a manufacturer of orthodontic appliances. The aligner is created based on the model of the patient's mouth. Accordingly, in embodiments in which the model of the patient's mouth includes the hybrid attachment(s), the aligner is created based not only on the natural features of the patient's mouth but also the location, size, number, positions, etc. of the hybrid attachment(s). The aligner is configured to be releasably retained by the hybrid attachment(s). That is, an inner surface of the aligner is configured to interact with the facial surface(s) of the hybrid attachment(s) to releasably retain the aligner. Though FIG. 9 refers to provision of only a single aligner and the generation of only a single model of the patient's mouth, such is not required. For example, these steps can be repeated as many times as desired. For example, the orthodontic clinician may desire to include a number of aligners in the patient's treatment. In such embodiments, the orthodontic clinician may generate multiple models of the patient's mouth during treatment and provide multiple aligners throughout the patient's treatment. As previously noted, the use of archwire and an aligner can be performed in series and/or parallel. In a serial treatment, the orthodontic clinician may secure the archwire and leave he archwire (or a series of archwires) in place for a period of time. The orthodontic clinician may remove the archwire and provide the aligner. As another example, the orthodontic clinician may first utilize one or more aligners then subsequently utilize one or more archwires to treat the patient.

While the discussion of FIGS. 8 and 9 provides additional detail regarding the use of hybrid attachments, the discussion of FIG. 10 describes a system for additively manufacturing hybrid attachments.

FIG. 10 is a block diagram of a system 1000 for providing data files associated with orthodontic appliances, according to some embodiments. As previously noted, hybrid attachments, as described herein, are a type of orthodontic appliance. Accordingly, the term “orthodontic appliance,” as used in the discussion of FIG. 9 includes hybrid attachments as described herein. The system 1000 includes a control circuit 1002, a database 1004, a user device 1010, and a manufacturing device 1018. One or more of the control circuit 1002, the database 1004, the user device 1010, and the manufacturing device 1018 are communicatively coupled via a network 1008. The network 1008 can include a local area network (LAN) and/or wide area network (WAN), such as the internet. Accordingly, the network 1008 can include wired and/or wireless links.

The user device 1010 can be any suitable type of computing device (e.g., a desktop or laptop computer, smartphone, tablet, etc.). The user device 1010 includes a display device 1012. The display device 1012 is configured to present a catalogue to a user. The catalogue includes orthodontic appliances that the user can obtain via the system 1000. For example, the catalogue can include all orthodontic devices that the user can purchase and/or manufacture via the manufacturing device 1018. The user interacts with the catalogue via a user input device 1014. The user can interact with the catalogue by navigating the catalogue, making selections from the catalogue, modifying orthodontic appliances included in the catalogue, etc. Accordingly, the user input device 1014 can be of any suitable type, such as a mouse, keyboard, trackpad, touchscreen, etc. The user device 1010 also includes a communications radio 1016. The communications radio 1016 transmits and receives information for the user device 1010. For example, in the case of a smartphone, the communications radio 1016 can be a cellular radio operating in accordance with the 4G LTE standard. Once a user has made a selection of an orthodontic appliance, the user device 1010, via the communications radio 1016 and the network 1008, transmits an indication of the selection to the control circuit 1002.

The control circuit 1002 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 1002 is configured (for example, by using corresponding programming as will be well understood by those skilled in the art) to carry out one or more of the steps, actions, and/or functions described herein.

By one optional approach the control circuit 1002 operably couples to a memory. The memory may be integral to the control circuit 1002 or can be physically discrete (in whole or in part) from the control circuit 1002 as desired. This memory can also be local with respect to the control circuit 1002 (where, for example, both share a common circuit board, chassis, power supply, and/or housing) or can be partially or wholly remote with respect to the control circuit 1002 (where, for example, the memory is physically located in another facility, metropolitan area, or even country as compared to the control circuit 1002).

This memory can serve, for example, to non-transitorily store the computer instructions that, when executed by the control circuit 1002, cause the control circuit 1002 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit may be remote from the user device 1010 and/or the manufacturing device 1018. For example, the user device 1010 and the manufacturing device 1018 may be located in a clinician's office (e.g., the user's office) whereas the control circuit 1002, and possibly the database 1004, are cloud-based. The control circuit 1002 generally operates to retrieve data files 1006 based on the user's selection of orthodontic appliances. The control circuit 1002 retrieves the data files 1006 from the database 1004. The database 1004 is configured to store the data files 1006. The data files 1006 are associated with orthodontic appliances. The data files 1006 are CAD files from which the orthodontic devices can be manufactured. The database 1004 stores a data file for each of the orthodontic appliances included in the catalogue. In one embodiment, the database 1004 stores a data file for all possible permutations of each orthodontic appliance (e.g., every possible modification and/or combination or modifications for each orthodontic appliance). The control circuit 1002 receives the indication of the orthodontic appliance and retrieves a data file based on the indication of the orthodontic appliance.

It should be noted that the indication of the orthodontic appliance may include more than one orthodontic appliance. For example, the indication of the orthodontic appliance can include multiple orthodontic appliances, such as full set of brackets and/or hybrid attachments for a patient. Accordingly, the data file can be a file including instructions and/or specifications for multiple orthodontic appliances. For example, the data file may include multiple data files and/or multiple specifications for a number of brackets and/or hybrid attachments.

After retrieving the data file, the control circuit 1002 transmits the data file. In some embodiments, the control circuit 1002 encrypts or otherwise protects the data file before transmission. The control circuit 1002 can encrypt or otherwise protect the data file before transmission to prevent those other than the user from accessing the data file. Additionally, in some embodiments, the control circuit 1002 can encrypt or otherwise protect the data file to control the user's access to the data file. For example, in some embodiments, the system is set up such that user's pay on a per manufacture or per print basis. That is, the user does not purchase, and may not later have access to, the data file. Rather, the user purchases access to print or otherwise manufacture an orthodontic appliance based on the data file once (or other specified number of times).

Dependent upon the embodiment, the control circuit 1002 transmits the data file to the user device 1010, the manufacturing device 1018, or a third-party device (e.g., a laboratory capable of manufacturing the orthodontic appliance for the user). To whom, or to what device, the data file is transmitted may also aid in achieving access control. For example, in one embodiment, the control circuit 1002 transmits the data file directly to the manufacturing device 1018. Because the data file is not transmitted to the user device 1010, the data file may not be easily accessible by the user device 1010. Further, if an entity that controls the control circuit 1002 controls the manufacturing device 1018, access may to files received by the manufacturing device 1018 may be further limited. In some embodiments, the control circuit 1002 transmits the data files to the user device 1010. In such embodiments, the user device 1010 transmits, via the communications radio (e.g., over a universal serial bus (USB) connection, wireless connection based on the 802.11 standard, etc.), the data files to the manufacturing device 1018.

The manufacturing device 1018 additively manufacturers the orthodontic appliance(s) based on the data file. The manufacturing device 1018 can be of any suitable type, such as a 3D printer. The manufacturing device 1018 can be local to, or remote from, one or more of the control circuit 1002 and the user device 1010. For example, in one embodiment, the user device 1010 and the manufacturing device 1018 are located in the user's office (i.e., the user device 1010 and the manufacturing device 1018 are local to one another). Alternatively, the manufacturing device 1018 may be located in a laboratory or some other facility that manufactures orthodontic appliances for the user.

In some embodiments, a hybrid attachment for orthodontic use comprises a body, wherein the body comprises an archwire slot, wherein the archwire slot is configured to receive an archwire, a bonding surface, wherein the bonding surface is configured to bond to a facial surface of a patient's tooth via an adhesive, and wherein the bonding surface is located on a first side of the body, and a facial surface, wherein the facial surface has nonnegative draft normal to the facial surface of the patient's tooth, and wherein the facial surface is configured to releasably retain a removable orthodontic aligner.

In some embodiments, a hybrid attachment for orthodontic use comprises a body, wherein the body comprises an archwire slot, wherein the archwire slot is configured to receive an archwire, a bonding surface, wherein the bonding surface is configured to bond to a facial surface of a patient's tooth via an adhesive, and a facial surface, wherein a portion of the facial surface contacts an inner surface of a removable orthodontic aligner, wherein the portion of the facial surface has a nonnegative draft with respect to a direction normal to the facial surface of the patient's tooth, and wherein the facial surface is configured to releasably retain the removable orthodontic aligner.

In some embodiments, a method for using an orthodontic system comprises providing one or more hybrid attachments, wherein each of the one or more hybrid attachments comprises a body, an archwire slot located on the body and configured to receive an archwire, a bonding surface configured to bond to a facial surface of a patient's tooth via an adhesive, and a facial surface having a nonnegative draft with respect to a direction normal to the facial surface of the patient's tooth, and configured to releasably secure a removable orthodontic aligner, securing the one or more hybrid attachments on a patient's teeth, generating a model of the patient's mouth, wherein the model includes the one or more hybrid attachments, and one or more of securing, within an archwire slot of at least one of the one or more hybrid attachments, the archwire, and providing the removable orthodontic aligner, wherein the removable orthodontic aligner is configured to be releasably retained by the one or more hybrid attachments within the patient's mouth.

In some embodiments, an orthodontic system comprises a hybrid attachment, wherein the hybrid attachment comprises a body, an archwire slot, wherein the archwire slot is configured to receive an archwire, and wherein the archwire slot is located on the body, a bonding surface, wherein the bonding surface is configured to bond to a facial surface of a patient's tooth via adhesive, and a facial surface, wherein the facial surface is configured to releasably retain a removable orthodontic aligner.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A hybrid attachment for orthodontic use, the hybrid attachment comprising:
a body, wherein the body comprises;
an archwire slot, wherein the archwire slot is configured to receive an archwire;
a bonding surface, wherein the bonding surface is configured to bond to a facial surface of a patient's tooth via an adhesive; and
a facial surface, wherein the facial surface has a nonnegative draft with respect to a direction normal to the facial surface of the patient's tooth, and wherein the facial surface is configured to releasably retain a removable orthodontic aligner.

2. The hybrid attachment of claim 1, wherein the removable orthodontic aligner interacts with the facial surface of the hybrid attachment to provide a force on the patient's tooth.

3. The hybrid attachment of claim 1, wherein the archwire slot is enclosed.

4. The hybrid attachment of claim 3, wherein the hybrid attachment further comprises a door, wherein the door provides access to and encloses the archwire slot.

5. The hybrid attachment of claim 1, wherein a perimeter of the bonding surface fits substantially flush against the patient's tooth.

6. The hybrid attachment of claim 1, wherein the archwire slot is curved.

7. The hybrid attachment of claim 1, wherein the hybrid attachment is additively manufactured.

8. The hybrid attachment of claim 1, wherein the bonding surface is located on a first side of the body and wherein the facial surface is located on a second side of the body.

9. A hybrid attachment for orthodontic use, the hybrid attachment comprising:
a body, wherein the body comprises;
an archwire slot, wherein the archwire slot is configured to receive an archwire;
a bonding surface, wherein the bonding surface is configured to bond to a facial surface of a patient's tooth via an adhesive; and
a facial surface, wherein a portion of the facial surface contacts an inner surface of a removable orthodontic aligner, wherein the portion of the facial surface has nonnegative draft with respect to a direction normal to the facial surface of the patient's tooth, and wherein the facial surface is configured to releasably retain the removable orthodontic aligner.

10. The hybrid attachment of claim 9, wherein the removable orthodontic aligner interacts with the facial surface of the hybrid attachment to provide a force on the patient's tooth.

11. The hybrid attachment of claim 9, wherein the archwire slot is enclosed.

12. The hybrid attachment of claim 11, wherein the hybrid attachment further comprises a door, wherein the door provides access to and encloses the archwire slot.

13. The hybrid attachment of claim 9, wherein a perimeter of the bonding surface fits substantially flush against the patient's tooth.

14. The hybrid attachment of claim 9, wherein the archwire slot is curved.

15. The hybrid attachment of claim 9, wherein the hybrid attachment is additively manufactured.

16. The hybrid attachment of claim 9, wherein the facial surface further comprises one or more undercuts, and wherein the one or more undercuts are configured to receive a ligature.

17. A method for using an orthodontic system, the method comprising:
providing one or more hybrid attachments, wherein each of the one or more hybrid attachments comprises a body, an archwire slot located on the body and configured to receive an archwire, a bonding surface configured to bond to a facial surface of a patient's tooth via an adhesive, and a facial surface having a nonnegative draft with respect to a direction normal to the facial surface of the patient's tooth and configured to releasably secure a removable orthodontic aligner;
securing the one or more hybrid attachments on a patient's teeth;
generating a model of the patient's mouth, wherein the model includes the one or more hybrid attachments; and
one or more of,
securing, within an archwire slot of at least one of the one or more hybrid attachments, the archwire, and
providing the removable orthodontic aligner, wherein the removable orthodontic aligner is configured to be releasably retained by the one or more hybrid attachments within the patient's mouth.

18. The method of claim 17, wherein the orthodontic aligner is configured to interact with the one or more hybrid attachments to provide a force on one or more of the patient's teeth.

19. The method of claim 17, wherein the archwire slot is enclosed.

20. The method of claim 19, wherein hybrid attachment includes a door, wherein the door provides access to and encloses the archwire slot.

21. The method of claim 17, wherein one or more of the one or more hybrid attachments and removable orthodontic aligner are additively manufactured.

22. The method of claim 17, wherein the model is generated from one or more of a physical impression and an optical scan.

23. An orthodontic system, the orthodontic system comprising:
a hybrid attachment, wherein the hybrid attachment comprises:
a body;
an archwire slot, wherein the archwire slot is configured to receive an archwire, and wherein the archwire slot is located on the body;
a bonding surface, wherein the bonding surface is configured to bond to a facial surface of a patient's tooth via adhesive,; and
a facial surface, wherein the facial surface is configured to releasably retain a removable orthodontic aligner.

24. The orthodontic system of claim 23, further comprising:
the orthodontic aligner, wherein the orthodontic aligner includes an inner surface and an outer surface, and wherein the inner surface is configured to interact with the facial surface of the hybrid attachment for the hybrid attachment to releasably retain the orthodontic aligner.

25. The orthodontic system of claim 23, wherein the inner surface interacts with the facial surface of the hybrid attachment to provide a force on the patient's tooth.

26. The orthodontic system of claim 23, wherein the archwire slot is enclosed.

27. The orthodontic system of claim 26, wherein the hybrid attachment further comprises a door, wherein the door provides access to and encloses the archwire slot.

28. The orthodontic system of claim 23, wherein a perimeter of the bonding surface fits substantially flush against the patient's tooth.

29. The orthodontic system of claim 23, wherein the archwire slot is curved.

30. The orthodontic system of claim 23, wherein the hybrid attachment is additively manufactured.

31. A method for using an orthodontic system, the method comprising:
providing one or more hybrid attachments, wherein each of the one or more hybrid attachments includes a body, an archwire slot located on the body and configured to receive an archwire, a bonding surface configured to bond to a facial surface of a patient's tooth via an adhesive, and a facial surface configured to releasably retain a removable orthodontic aligner;
securing the one or more hybrid attachments on a patient's teeth;
securing, within an archwire slot of at least one of the one or more hybrid attachments, the archwire;
generating a model of the patient's mouth, wherein the model includes the one or more hybrid attachments;
providing the removable orthodontic aligner, wherein the orthodontic aligner is generated based on the model, and wherein the orthodontic aligner is configured to be releasably retained by the one or more hybrid attachments.

32. The method of claim 31, wherein the orthodontic aligner is configured to interact with the one or more hybrid attachments to provide a force on one or more of the patient's teeth.

33. The method of claim 31, wherein the archwire slot is enclosed.

34. The method of claim 33, wherein hybrid attachment includes a door, wherein the door provides access to and encloses the archwire slot.

35. The method of claim 31, wherein one or more of the one or more hybrid attachments and removable orthodontic aligner are additively manufactured.
